(19) United States
(12) Patent Application Publication
(10) Pub. No.: US 2025/0111020 A1
(43) Pub. Date: Apr. 3, 2025

(54) USER AUTHENTICATION

(71) Applicant: Peratech IP Ltd, North Yorkshire (GB)

(72) Inventors: Apostolos T. Voutsas, Vancouver, WA (US); Fawad Ahmad, Solna (SE)

(73) Assignee: Peratech IP Ltd, North Yorkshire (GB)

(21) Appl. No.: 18/900,495

(22) Filed: Sep. 27, 2024

(30) Foreign Application Priority Data
Sep. 29, 2023 (GB) 2315013.9

(51) Int. Cl. G06F 21/31; G06F 3/041; G06F 3/04886

(52) U.S. Cl. CPC G06F 21/31; G06F 3/0414; G06F 3/04886

(57) ABSTRACT

Examples disclosed relate to user authentication including an apparatus configured to: receive signalling indicative of one or more user inputs in a sequence provided to a sensing surface of a force sensor, each of the user inputs of the sequence having an associated position and an associated force; compare the associated position and the associated force of each of the user inputs in the sequence with a passcode position and a passcode force of a passcode sequence, the passcode sequence stored in a memory accessible by the apparatus; and output an positive authentication indication in response to the associated position and the associated force of each of the user inputs in the sequence matching the corresponding passcode position and the passcode force of the passcode sequence.

### TECHNICAL FIELD

The present disclosure relates to user authentication, in particular user authentication using a force sensing apparatus. The present disclosure also relates to an apparatus for user authentication, a system comprising the apparatus and a force sensor, a method for user authentication, and computer program code.

### BACKGROUND

A user may be able to unlock access to functionality of a device by providing some form of user authentication. This may be traditionally by entering a pin number or password. However it can be challenging to ensure that the password has been entered by a genuine user of the system rather than an unauthorised user who has gained unauthorised access to the password.

Ways to try and combat such unauthorised access include further authentication steps such as using facial recognition, or two factor authentication whereby the user is provided with an additional code and is prompted to enter this as well as the password. However, alongside the drawback of the user authentication process being more complicated by these additional steps, the additional steps may also themselves be problematic. For example, facial recognition may cause a user's device to be unlocked inadvertently by detecting the user's face even if the user did not want their device to become unlocked. As another example, if a user's communications are being intercepted, then the unauthorised user who entered the password may also be able to intercept the further code provided for two factor authentication and still gain access.

Examples disclosed herein aim to solve such problems in the art.

### BRIEF SUMMARY OF THE DISCLOSURE

Aspects and embodiments of the invention provide an apparatus for user authentication, a system comprising the apparatus and a force sensor, a method for user authentication, and computer program code.

In accordance with the present disclosure there is provided an apparatus for user authentication, the apparatus configured to: receive signalling indicative of one or more user inputs in a sequence provided to a sensing surface of a force sensor, each of the user inputs of the sequence having an associated position and an associated force; compare the associated position and the associated force of each of the user inputs in the sequence with a passcode position and a passcode force of a passcode sequence, the passcode sequence stored in a memory accessible by the apparatus; and output an positive authentication indication in response to the associated position and the associated force of each of the user inputs in the sequence matching the corresponding passcode position and the passcode force of the passcode sequence. Advantageously both the position and force of a user input are part of the passcode, adding to the security of user authentication without requiring additional authentication stages.

Each of the associated positions may correspond to respective keys of a keyboard, the respective key having an associated key value and configured to apply force to the force sensor at the corresponding associated positions, and wherein the passcode position of a passcode sequence corresponds to an associated passcode key value. Thus the method may be performed using a force sensitive keyboard or virtual keyboard on a force sensitive touchscreen.

The apparatus may be further configured to output a negative authentication indication in response to determining that the associated position and the associated force of each of the user inputs in the sequence do not match the corresponding passcode position and the passcode force of the passcode sequence. Thus the user is informed if their attempt to obtain authorised access fails.

The passcode position and the passcode force of the passcode sequence may be combined and hashed. The apparatus may be configured to: hash the associated position and the associated force of each of the user inputs in the sequence using the same hashing method as that used to hash the passcode position and the passcode force of the passcode sequence; compare the hashed sequence with the hashed passcode sequence; and output the positive authentication indication in response to the hashed sequence matching the hashed passcode sequence. The associated position and the associated force of each of the user inputs in the sequence may be hashed together to provide a single hashed sequence. Hashing of the position and force data of the passcode increases security and makes it more difficult to an unauthorised user to gain access to the user's credentials. In some examples the position and force data of the passcode may be encrypted rather than hashed.

The associated force may fall within an associated force range of a plurality of predetermined force ranges. Each of the one or more passcode forces may be associated with a corresponding predetermined force range of the plurality of predetermined force ranges. The apparatus may be configured to: compare the associated force to the plurality of predetermined force ranges; determine an associated force range of the plurality of predetermined force ranges into which the associated force falls; compare the associated force range of each of the user inputs in the sequence with the passcode force range of the passcode sequence, the passcode force range being one of the plurality of predetermined force ranges; and output an positive authentication indication in response to the associated position and the associated force range of each of the user inputs in the sequence matching the corresponding passcode position and a corresponding passcode force range of the passcode sequence. Thus there is some window of force which the user can enter an input with, allowing the advantage of using force levels as a passcode element without requiring overly precise force input to improved repeatability.

The plurality of predetermined force ranges may have respective upper and lower force bounds, the respective upper and lower force bounds determined according to a sample of user inputs provided to the sensing surface of the force sensor. The apparatus may be configured to: process the received signalling indicative of one or more user inputs in a sequence having an associated position and an associated force using an trained AI model to determine the associated force. For example, an AI model may be trained using position and force input data from a particular user to determine a user use signature characteristics of the user's unique manner of interacting with the input device which is receiving the position and force user inputs. This user use signature may be stored and compared to a later passcode entry, and the user entering the later passcode may be determined to be the authorised user if there is a match (e.g. above a predetermined match threshold) between the detected use signature and the stored use signature for the user.

The positive authentication indication may comprise one or more of: a visual indicator output to alert a user of the apparatus that the entered sequence matches the stored passcode; an audio indicator output to alert a user of the apparatus that the entered sequence matches the stored passcode; a haptic indicator output to alert a user of the apparatus that the entered sequence matches the stored passcode; and unlocking functionality of a device associated with the stored passcode. The user is thereby clearly informed that their passcode entry has been successful.

The apparatus may be further configured to, in response to receiving each of the user inputs having an associated position and an associated force, output a force input indicator indicative of a magnitude of the force applied. The force input indicator may comprise one or more of: a visual force indicator displayed on a display screen connected to the force sensing apparatus; an audio force indicator output by an audio output device connected to the force sensing apparatus; and a haptic force indicator output connected by a haptic output device connected to the force sensing apparatus. The user is advantageously informed of the force with which they are applying a force input, which can help them to enter their passcode accurately while still helping to prevent an unauthorised user to see what the user's passcode is.

In an aspect there is provided a system comprising: any apparatus disclosed herein, and a force sensor configured to detect the position and the force of a user input provided to a sensing surface of the force sensor, and transmit the signalling indicative of one or more user inputs in a sequence provided to the sensing surface of the force sensor to the apparatus. Thus the apparatus and force sensor together may be used to facilitate secure user access to a device.

The system may comprise at least one control module connected to the force sensor. The control module may be configured to convert an analogue force signal received from the force sensor in response to a force applied to the force sensor, to a digital force signal representative of the force applied to the force sensor.

The system may comprise a plurality of keys forming a keyboard. Each key of the plurality of keys may be configured to, when a force is applied to that key, apply a corresponding force to the force sensor at a position corresponding to that key.

The system may comprise a display surface configured to display a virtual keyboard comprising a plurality of virtual keys. Each virtual key of the plurality of virtual keys may be configured to, when a force is applied to that virtual key, apply a corresponding force to the force sensor at a position corresponding to that virtual key. The system may form a keyboard device.

In an aspect there is provided a method for user authentication, the method comprising: receiving signalling indicative of one or more user inputs in a sequence provided to a sensing surface of a force sensor, each of the user inputs of the sequence having an associated position and an associated force; comparing the associated position and the associated force of each of the user inputs in the sequence with a passcode position and a passcode force of a passcode sequence, the passcode sequence stored in a memory accessible by the apparatus; and outputting a positive authentication indication in response to the associated position and the associated force of each of the user inputs in the sequence matching the corresponding passcode position and the passcode force of the passcode sequence.

Outputting the positive authentication indication in response to the associated position and the associated force of each of the user inputs in the sequence matching the corresponding passcode position and the passcode force of the passcode sequence may comprise unlocking functionality of a device associated with the stored passcode.

In an aspect there is provided computer program code which, when executed on a processor, is configured to perform any method disclosed herein. In an aspect there is provided a non-transitory computer readable medium storing any computer program code herein.

### BRIEF DESCRIPTION OF THE DRAWINGS

Example embodiments are further described hereinafter with reference to the accompanying drawings, in which:

FIG. 1 shows schematically an apparatus for user authentication according to examples disclosed herein;

FIG. 2a shows an example sequence of user input positions and FIG. 2b shows an example sequence of corresponding user input forces for a user entered passcode according to examples disclosed herein;

FIG. 3a shows an example force enabled keyboard and FIG. 3b schematically shows an example force enabled keypad with key positions indicated according to examples disclosed herein;

FIGS. 4a and 4b illustrate examples of hashing a sequence of user input positions and corresponding user input forces according to examples disclosed herein;

FIG. 5 shows a schematic illustration of a force-resistance relationship for a force sensor with force regions indicated according to examples disclosed herein;

FIG. 6 illustrates an example system for user authentication according to examples disclosed herein;

FIG. 7 illustrates an example workflow of user authentication according to examples disclosed herein; and

FIG. 8 illustrates an example method of user authentication according to examples disclosed herein.

### DETAILED DESCRIPTION

Force sensing technology can be used in electronic devices to allow an input to be made to the electronic device which is dependent on the magnitude of the force applied to an input element, such as to a key of a keyboard. For example, a light press on a key may cause a different input to be made than if a heavier press is made on the same key.

A user may be able to unlock access to functionality of a device by providing some form of user authentication. This may be traditionally by entering a pin number or password. However it can be challenging to ensure that the password has been entered by a genuine user of the system rather than an authorised user who has gained unauthorised access to the password. Methods to try and combat unauthorised use of a password can complicate the user authentication process by requiring additional information to be entered, and such information may also fall into the hands of an authorised user, may unnecessarily complicate authorization for a user, may require additional computational functionality or processing power (such as using facial recognition or fingerprint sensing which require additional hardware to perform the imaging/sensing), and may still be overcome by a more sophisticated unauthorised user. 35

Attempting to recognise the manner in which a user enters a password by analysing their typing cadence requires behavioural analysis on a large set of user typing which is burdensome and requires computational resources, and cannot easily be changed or adapted, for example if the user's physical abilities change over time and therefore affect their typing cadence, or simply if the user wishes to change the authentication credentials. Artificial intelligence approaches to classify character input signals using triboelectric keystroke signalling using a support vector machine are computationally intensive, particularly for low power devices, and require training data for the support vector machine to be able to classify the user's input. Furthermore such approaches assume that the electrical signals arising from the user entering characters of a password stay constant, and would not be affected by real world factors such as temperature, durability, and humidity, which is not accurate.

Examples disclosed herein aim to overcome this problem by recognising that a force enabled password entry device, such as a force enabled keyboard or touch screen, may be used to allow a user to enter a password, wherein each character of the password has a corresponding character selection and a corresponding force factor. For example a particular key may be pressed to provide the character of the password and the force with which the key is pressed to provide that character may also be used to provide the force factor.

Therefore, rather than a password being a string of characters, the password comprises both the string of characters and the force with which each of those characters is entered. The user still enters one passcode, and does not need to provide a different biometric input such as facial recognition or fingerprint sensing, nor does the user need to enter a second passcode or perform an additional authentication process in the manner of two factor authentication.

Furthermore, while a password may potentially be compromised by an unauthorised user watching the user entering the password and remembering the characters, or using a remote keystroke logger, the unauthorised user would not be able to discern the force with which the characters are being entered by the user, and therefore would not be able to gain unauthorised access to the user's accounts or device functionality by copying the password characters, since the forces used to enter the keypresses would not be known.

That is, methods of authentication disclosed herein are able to sense forces on keys when the user presses the keys. Such methods do not add unnecessary steps for the user, as the user will only be typing in the password. Instead of adding analogue (continuous) input recognition, some examples use windows/ranges of force levels, such as “light”, “medium”, and “heavy” force, thereby improving the repeatability of password entry and accommodating variations in user use and external factors such as temperature. The methods disclosed herein do not require training by entry of sample texts by the user, and relatively short passwords are still strong due to the additional information on force levels supplementing the choice of characters in the password.

Finally, the use of a force enabled keyboard to enter the passwords as disclosed herein can add a level of security, since the passcode must be entered using an input device which is force enabled, such as a force enable keyboard physically attached to a system to which the user wants to gain access (that is, an unauthorised user without a force enabled input device is unable to provide the required authentication inputs).

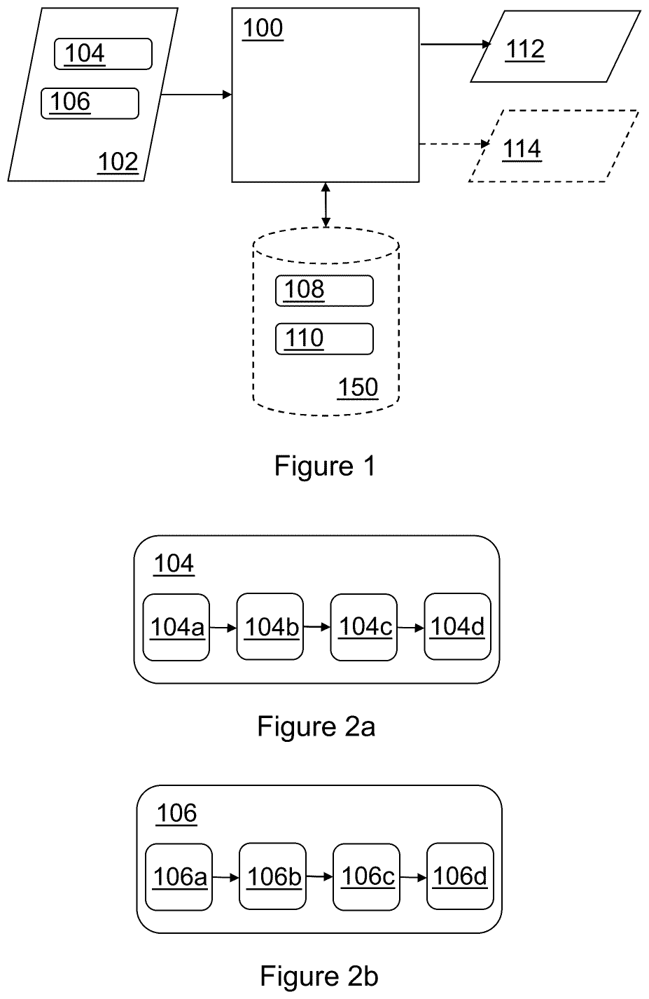

FIG. 1 shows schematically an apparatus 100 configured for user authentication. The apparatus 100 is configured to receive signalling 102 indicative of one or more user inputs in a sequence provided to a sensing surface of a force sensor. Each of the user inputs of the sequence has an associated position 104 and an associated force 106. That is, the user enters a passcode to a force-sensitive device and the signalling representing the inputs 100 is received by the apparatus 100. The terms “passcode” and “password” are used interchangeably in this document and refer to the user's secret combination of characters with associated character entry forces used to gain access to some functionality of a device.

For example, a user's passcode may be the six characters “ABC123” which are entered by the user pressing keys on a keyboard (real or virtual), and thus the positions of those keys are the associated positions of the user inputs used to enter the passcode. The characters may each be pressed with a particular force, such as “A” with a light press, “B” with a medium press, “C” with a heavy press, “1” with a heavy press, “2” with a medium press, “3” with a light press”. Thus each of the positions (e.g. key positions) has an associated force. To correctly enter the passcode, the user needs to enter the passcode which may be represented as six key entries each having an associated force with which the key is to be pressed-(A, light; B, medium; C, heavy; 1 heavy; 2 medium; 3 light).

The apparatus 100 is configured to compare the associated position 104 and the associated force 106 of each of the user inputs in the sequence with a passcode position 108 and a passcode force 110 of a passcode sequence. The passcode sequence is stored in a memory 150 accessible by the apparatus 100. In other words, the user's passcode is compared with a stored passcode 108, 110 for that user to see if the passcodes match. The memory 150 may be a part of the apparatus 100 in some examples, and in other examples as shown, may be external to and accessible by the apparatus 100.

The apparatus 100 is configured to output an positive authentication indication 112 in response to the associated position 104 and the associated force 106 of each of the user inputs in the sequence matching the corresponding passcode position 108 and the passcode force 110 of the passcode sequence. Thus if the user's passcode matches the stored passcode, there is some positive output, such as unlocking device functionality, allowing access to a file or application, and/or providing an “unlock successful” indication.

The positive authentication indication 112 may be, for example, a visual indicator output to alert a user of the apparatus 100 that the entered sequence matches the stored passcode. This may be a displayed message (e.g. “Access Granted”), illumination of a light such as an LED or illumination of a portion of a display screen, such as a border of a displaying screen flashing green to show the passcode entry was successful. The positive authentication indication 112 may be, for example, an audio indicator output to alert a user of the apparatus that the entered sequence matches the stored passcode, such as a ping or audio message “unlocked”. The positive authentication indication 112 may be, for example, a haptic indicator output to alert a user of the apparatus that the entered sequence matches the stored passcode such as a vibrator of a handheld portion of a device buzzing or buzzing in a particular pattern to indicate successful authentication.

The positive authentication indication 112 may be, for example, unlocking functionality of a device associated with the stored passcode, such as unlocking functionality of a portable electronic device so it can be used to e.g. make calls or access the internet, or allowing access to an application running on a device, allow access to a password-entry portal such as an online banking website or a booking application, or allowing access to view or use a passcode protected file using that device (e.g. view a spreadsheet, image, or other document).

In some examples, the apparatus 100 may be further configured to output a negative authentication indication 114 in response to determining that the associated position 104 and the associated force 106 of each of the user inputs in the sequence do not match the corresponding passcode position 108 and the passcode force 110 of the passcode sequence. This may be an audible tone, a vibration, and/or a displayed indication such as a display screen being greyed out, a shake effect to appear as if the displayed contents of a display screen are shaking side to side, or a message to indicate failed passcode entry such as “Denied” or “Passcode incorrect”.

FIG. 2a shows an example sequence of user input positions and FIG. 2b shows an example sequence of corresponding user input forces for a user entered passcode.

FIG. 2a shows a sequence of user input positions 104 comprising four positions 104a-d. The positions may correspond to keys on a real or virtual keyboard or keypad, or in some examples, may correspond to regions of a touch sensitive surface which are not demarked into particular regions such as individual keys. FIG. 2b shows a sequence of user input forces 106 comprising four applied forces 106a-d. The forces may correspond to predefined force ranges in some examples.

For example, a user may be able to unlock functionality of a device by providing a series of key presses with particular forces such as “P (light)-A (heavy)-S (medium)-S (heavy)” wherein position P is the first position 104a, position A is the second position 104b, position S is the third position 104c and position S is also the fourth position 104d; and wherein force (light) is the first force 106a, force (heavy) is the second force 106b, force (medium) is the third force 106c and force (heavy) is also the fourth position 106d. Another example may be “A (light)-5 (heavy)-G (medium)-2 (very light)”. As another example, a user may be able to unlock functionality of a device by providing an input to a top left corner of a touch sensitive screen with a heavy press, then an input to a bottom edge of the touch sensitive screen with a light press, then an input to a top right corner of the touch sensitive screen with a medium press followed by an input in the same region with a light press, even if those regions are not marked as being special “touch” regions. In some examples the positions may be a combination of demarked regions (keys) and unmarked regions (e.g. a corner, centre, or edge of a touch sensitive panel).

In some examples, the apparatus 100 may be configured to, in response to receiving each of the user inputs having an associated position and an associated force, output a force input indicator indicative of a magnitude of the force applied. The force input indicator may comprise a visual force indicator displayed on a display screen connected to the force sensing apparatus. For example, if the user is pressing on a key or region of a touch sensitive surface, a visual indicator may be displayed to show how much force the user is applying to that key/region. The indicator may, for example, show one, two, or three bars in a stacked configuration to indicate a light, medium, or heave force press respectively In some examples there may be a colour indicator, such as green for a light press, amber for a medium press, and red for a heavy press. The visual indicator may be a variable brightness indication wherein a harder/more forceful press causes a brighter light to be displayed. Such a light may be displayed on or bordering the key/location being pressed in some examples. In some examples, the force input indicator may comprise an audio force indicator output by an audio output device connected to the force sensing apparatus (e.g. one, two, or three tones in quick succession dependent on the force applied); and/or a haptic force indicator output connected by a haptic output device connected to the force sensing apparatus (e.g. a stronger vibration is provided in response to a harder key press).

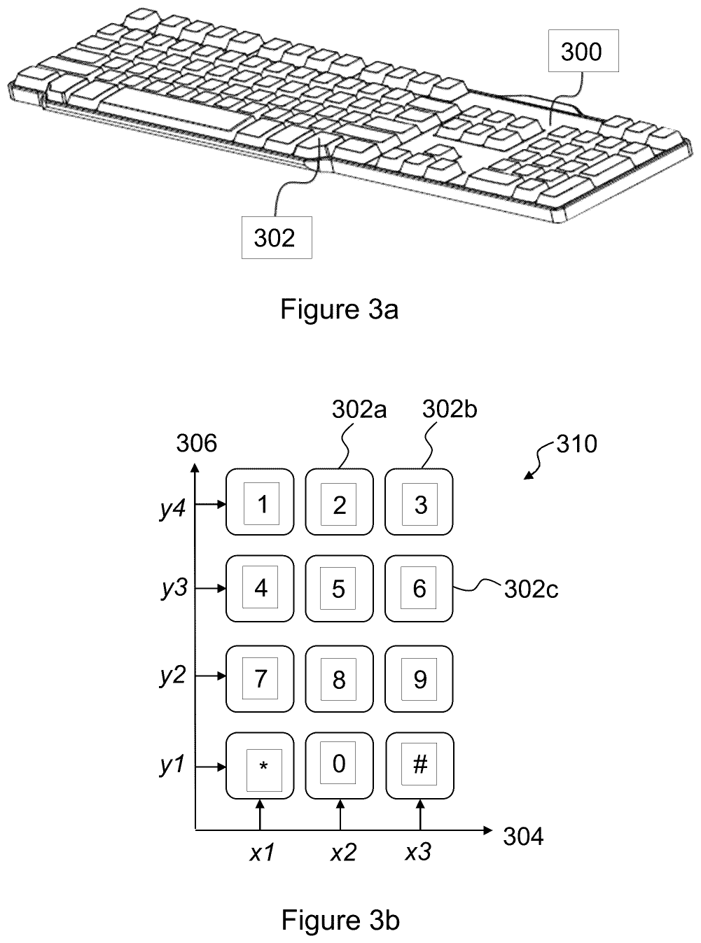

FIG. 3a shows an example of a force enabled keyboard 300 comprising a plurality of keys 302. FIG. 3b shows an example of a force enabled keypad 310 with key positions indicated. It will be appreciated that the following discussion about a keypad can be applied to other input devices capable of receiving inputs having an associated position and an associated force such as the keyboard 300 or a touch (force) sensitive screen, for example.

The keys 302a-c of the keypad 310 in FIG. 3b are each at a respective position which may be denoted as an x value 304 and y value 306 in this illustration. For example, the “2” key 302a is at position (x2, y4) and the “6” key 302c is at position (x3, y3). Each respective key also has an associated key value as well as a position (e.g. “2”, “6” in this example). Each key 302a-c is configured to apply force to a force sensor (for example a force sensitive membrane underlying the keys 302a-c) at the corresponding associated positions. A user entering a passcode using the keys 302a-c provides force inputs to keys having the position values of the keys in the passcode. The passcode position of a passcode sequence corresponds to an associated passcode key value and has an associated force with which the input is provided.

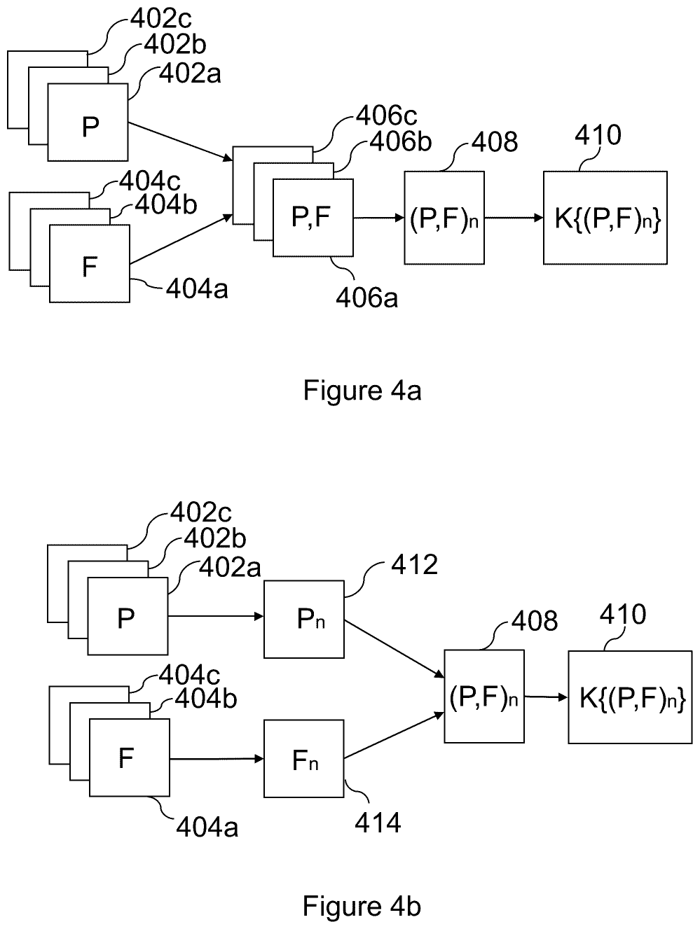

FIGS. 4a and 4b illustrate examples of hashing a sequence of user input positions 402a-c and corresponding user input forces 404a-c. The passcode position 402a-c and the passcode force 404a-c of the passcode sequence may be combined 406a-c; 408 and hashed 410. The user input positions 402a-c may be, for an example of a passcode “A-C-E”, the position of the “A” key 402a, the position of the “C” key 402b, and the position of the “E” key 402c. The user input forces 404a-c may be, for the example of the passcode “A (light force)-C (medium force)-E (heavy force)”, the light force of the “A” key 404a, the medium force of the “C” key 404b, and the heavy force of the “E” key 404c. The inputs must be made, in some examples, in the same sequence or order as the passcode stored in the memory. In some examples, there may be no set sequence and the positions with associated forces may be entered in any order.

These examples use hashing, both in other examples encryption could be used. Both method are similar to the extent that both allow an encoded version of the force and position data to be stored which cannot readily be understood in order to obtain the actual position and force data. However, hashing is a one-way function whereas encryption is a two-way process. In hashing, data (i.e. position and force data) is mapped to a fixed-length value. Once that information is hashed (and therefore “hidden”) it cannot be restored back to obtain the original information. Encryption is two-way function, whereby information encrypted/hidden can be decrypted/restored to obtain the original information. Using a hashing function ensures the stored information cannot be processed (solved mathematically in reverse direction) to obtain the original information. For example, the hash function of a password “ACE” may be “a83f45c762a8884890ff551893fd50ab31af758a” and the original password cannot be obtained from that hash only. So a hash function only gives the same hash if the input information is the same. Once a hash is obtained with position and force data, the same hash can only be obtained if the position and force are same. Once the hashed position and force range is hashed no-one can find what was position and force was, even if the stored hash is leaked/obtained.

FIG. 4a shows that the associated position 402a-c and the associated force 404a-c of each of the user inputs in the sequence are combined to a series 408 of position-force inputs 406a-c (for example, a first entry “A, light force” 406a, a second entry “C, medium force” 406b and a third entry “E, heavy force” 406c). This sequence of position-plus-force inputs (P,F)ₙ 406a-c is then combined to a single string 408 which is hashed K(P,F)ₙ 410. FIG. 4b shows that the associated position 402a-c and the associated force 404a-c of each of the user inputs in the sequence are individually combined to provide a position string Pₙ 412 and a force string Fₙ 414, which are combined to a series of position-plus-force inputs (P,F)ₙ 408 is then combined to a single string 408 which is hashed K(P,F)ₙ 410.

The apparatus 100 may be configured to hash the associated position 402a-c and the associated force 404a-c of each of the user inputs in the sequence using the same hashing method as that used to hash the passcode position and the passcode force of the passcode sequence which is stored in a memory. The apparatus 100 may then compare the hashed sequence 410 with the hashed passcode sequence stored in the memory. The apparatus 100 may then output the positive authentication indication in response to the hashed sequence 410 matching the stored hashed passcode sequence. The associated position 402a-c and the associated force 404a-c of each of the user inputs in the sequence may be hashed together to provide a single hashed sequence 410.

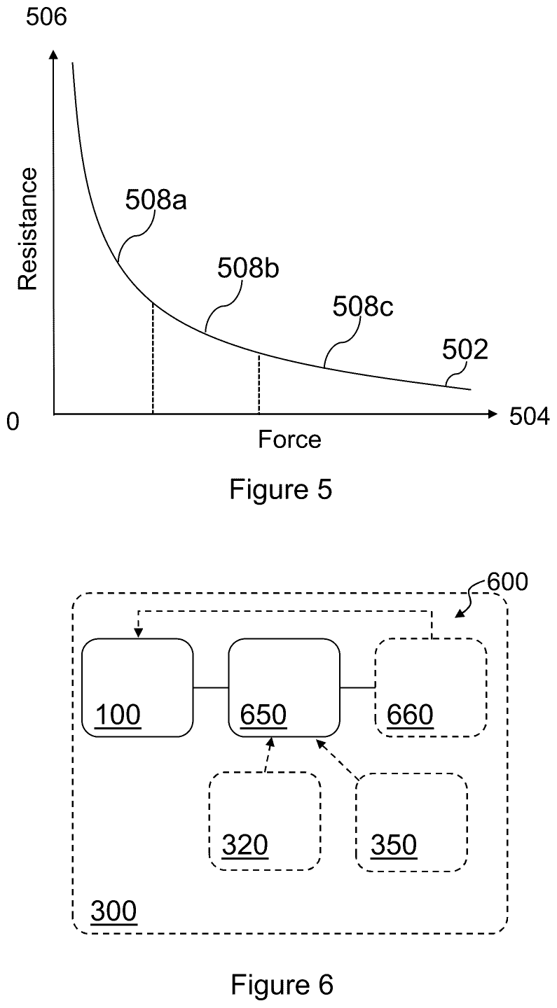

FIG. 5 shows a schematic illustration of a force 504-resistance 506 relationship 502 for a force sensor with force regions indicated. As the force applied increases, the resistance of a resistive force sensor decreases, and this change in resistance is detected and used to determine the applied force. A user may press a force sensitive key or other force touch input element (e.g. a touch sensitive screen) with a force which can vary over a continuum. Thus in some examples, to aid reproducibility of passcode entry, the possible forces which can be registered by the force sensor may be binned into force ranges. Provided a force input is applied within the same force range as the force range recorded in the stored passcode, the force entry can be determined to match.

That is, rather than pairing a force or normalised force with the position (e.g. character), a force level with in arrange may be paired with a position. It is improbable that a user will be able to press with the precise amount of force (even with a small tolerance factor e.g. +/−2% or 5%) at different times. Also, some examples electronic processing force signals may not necessarily generate an identical signal for an identical applied force. Thus, using a selection of force ranges helps to overcome issues with reproducibility of force application.

In some examples, to determine the force zones, a user may press a key with different forces as instructed in a calibration step. Normalisation of the possible applied forces may be performed. In some examples there may be a linear increase in applied force between normalised values of 0 and 1. In other examples, there may be a non-linear distribution of applied force between normalised values of 0 and 1. For example, if the application of a force categorised as “light” can readily be reproduced in a smaller range of forces (e.g. over 20 g variation), whereas the application of a force categorised as “heavy” has a larger force variation (e.g. over 60 g variation), then the sizes of the force zones may be different to accommodate these differences in variation for particular force level.

For example, a force range of 50 g-100 g may be used and the first character of the stored passcode may be entered with a force of 60 g, within this range. Provided, when the user enters the first character of the passcode later to access functionality of the device, the force used is between 50 g and 100 g, the force can be determined to match the stored passcode, even if it is not quite the same (e.g. it could be 80 g or 90 g but still within the same range). In the example of FIG. 5, there are three non-overlapping force ranges 508a-c, but in other examples there may be more or fewer ranges. In other examples there may be overlap of the ranges (e.g. a first range of 50 g to 120 g and a second range from 100 g to 200 g).

Thus, the associated force of a user input may fall within an associated force range of a plurality of predetermined force ranges 508a-c. Each of the one or more passcode forces may be associated with a corresponding predetermined force range of the plurality of predetermined force ranges 508a-c. The apparatus 100 may be configured to compare the associated force to the plurality of predetermined force ranges 508a-c; determine an associated force range of the plurality of predetermined force ranges 508a-c into which the associated force falls; compare the associated force range of each of the user inputs in the sequence with the passcode force range of the passcode sequence, the passcode force range being one of the plurality of predetermined force ranges 508a-c; and output a positive authentication indication in response to the associated position and the associated force range of each of the user inputs in the sequence matching the corresponding passcode position and a corresponding passcode force range of the passcode sequence.

The plurality of predetermined force ranges 508a-c have respective upper and lower force bounds which are determined according to a sample of user inputs provided to the sensing surface of the force sensor in some examples.

In some examples, the apparatus 100 may be configured to process the received signalling indicative of one or more user inputs in a sequence having an associated position and an associated force using an trained AI model to determine the associated force. An AI algorithm can, for example, be trained to recognize one or more users that have access to the device by the way they operate the device (e.g. their specific typing patterns which are unique to them). A force-enabled keyboard can help establish this unique fingerprint/pattern (which may be called a “user's use signature”) by sensing the forces, positions and/or movements a user uses when interacting with the keyboard. Then, even after a user successfully logs onto a device, the unique use signature for the user can provide a further level of authentication, since it will be unique to that user and be very difficult, or impossible, to imitate by someone else. For example, the determined force a user uses to press one or more input elements may be detected and fed to an AI model to determine a unique “force signature” with which the user has pressed the input elements for future authentication of that user providing the same “force signature”.

FIG. 6 illustrates an example system 600 for user authentication. The system 600 comprises any apparatus 100 disclosed herein, and a force sensor 650 configured to detect the position and the force of a user input provided to a sensing surface of the force sensor, and transmit the signalling indicative of one or more user inputs in a sequence provided to the sensing surface of the force sensor 650 to the apparatus 100. The system 600 may comprise at least one control module 660 connected to the force sensor 650. The control module 660 may be configured to convert an analogue force signal received from the force sensor 650 in response to a force applied to the force sensor, to a digital force signal representative of the force applied to the force sensor. This digital force signal may be provided to the apparatus 100 for use in determining whether the user entered passcode matches a stored passcode.

The system 600 may comprise a plurality of keys 320 forming a keyboard 300. Each key of the plurality of keys 320 may be configured to, when a force is applied to that key, apply a corresponding force to the force sensor 650 at a position corresponding to that key. This may be by way of a force sensitive membrane e.g. underlying the keys, which receives a force when a key is pressed. The system 600 may comprise a display surface 350 configured to display a virtual keyboard comprising a plurality of virtual keys. Each virtual key of the plurality of virtual keys may be configured to, when a force is applied to that virtual key, apply a corresponding force to the force sensor 650 at a position corresponding to that virtual key. The system 600 may form a keyboard device 300 in some examples (that is, the apparatus 100 and force sensor 650 may be housed in a keyboard housing with the keys 320 and force sensor 650, and/or virtual keyboard on a touch sensitive display surface 350).

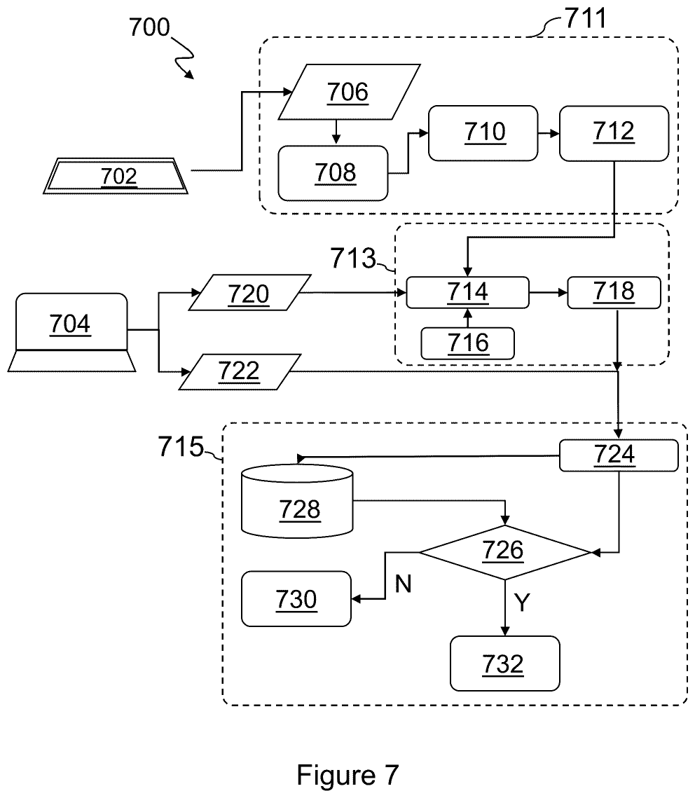

FIG. 7 illustrates an example overall workflow 700 of user authentication. The workflow 700 shows a force sensitive resistor (FSR) input device 702, such as a keyboard, and a device running software 704, such as an operating system. The FSR input device 702 may be used to perform signal processing steps 711 in which the input device is calibrated to receive passcodes comprising position information and force information. The software running on the device 704 may perform cryptography 713 to record a user's desired passcode and securely store it for future authentication, and authentication 715 to later receive an input passcode and compare it to the cryptographically stored passcode for the purposes of user identification and authentication. It will be appreciated in other examples, different steps may be performed on different processing devices (for example, the software 704 may perform the signal processing steps 711). While this example relates to a force sensitive resistor input device, other examples which may be used according to this disclosure are any input device which is configured to sense position and force of user input (e.g. a capacitive force sensor, or a sensor which is able to detect changes in electric and/or magnetic field proximal to a sensing surface). The particular mechanics of how the force signal is detected (e.g. through force sensitive resistors) is not important for the examples disclosed herein to be implemented.

The signal processing step 711 as shown is performed to calibrate the input signals received from a user. As illustrated, a position and force signal is provided from the FSR input device 702 in a signal acquisition step 706. The signal is then used for FSR calibration in step 708, the results of which are then normalised in step 710 and classified in step 712. Calibration 708 may be performed by selecting a maximum force and a minimum force according to the capabilities of the force sensing resistor and the associated electronics. For example, a minimum force of 80 g and a maximum force of 400 g may be detectable and used to set the lower and upper bounds respectively of the force which may be detected. There may be plural force regions within these two boundary values as discussed in relation to FIG. 5. Normalisation 710 may be performed to, for example, set a force range between 0 and 1, with any forces lower than or equal to the lower boundary (e.g. 80 g) being a 0, and any forces higher than or equal to the upper boundary (e.g. 400 g) being a 1, and forces between these two values being a value between 0 and 1.

In some examples, continuous values of normalised force data may be provided for processing. Force data arising from a user pressing an input element such as a force sensitive key may be recorded during the key press and the release. A peak of the force signal may be selected and used as the input force with which the key has been pressed. This is because it may be difficult to obtain a clear force signal if, for example, the user chooses to press the key very slowly which may not provide a clear rise and fall of the applied force signal.

Cryptography stage 713 receives an entered passcode 720 from the user and then hashes it. This passcode entry is performed by the authorised user for the purposes of initially setting up the passcode credentials for future authentication. The illustrated cryptographic method 713 comprises using a hashing algorithm 714 on the received passcode 720, including in this example the use of a hash salt 716 to provide a hash string 718. The hash string 718 is provided along with a user identifier or username 722 to the authentication stage 715 as part of the user profile 724, which records identifying information for a particular user.

An example of hashing which may be used is a “Password-based key derivation function 2” (Pbkdf2) which uses a pseudorandom function to generate salt of size 64 bytes and performed 350,000 hash iterations using SHA512 to produce a derived key of size 64. When the user enters a passcode, it may be compared to the generated hash using Pbkdf2. In some examples, only the stored hash stored in the database may be compared to a hash of the entered passcode. This cryptographic hash function is a one-way function that cannot easily be reversed, so resistance against rainbow table and dictionary attacks is achieved. Other examples are also included in this disclosure which use a different type of hashing function-provided the passcode (position and force) is hashed in some way then the advantage of secure storage is obtained. In some examples has string 718 and user identifier 722 together form the user profile 724, which is saved in the database 728. The user information 724, hash salt 716 and number of force zones may be saved in the database 728, for example in cloud storage, for future use against an entered passcode.

In some examples, rather than using hashing to securely store the position and force sequence information, encryption may be used in the same way. However, whereas hashing is a one-way operation, encryption is a two-way operation provided the appropriate key is available. In examples where is it not required to know what the positions and forces in the sequence actually are (and therefore there is no need to be able to recover those parameters by decrypting the encrypted parameters), hashing may provide a more secure method as there is no way the original position and force inputs can be recovered from the storage from the hash.

The authentication step 715 illustrates the use of the authentication system following being set up by calibration in step 711 and setting the user credentials in step 713. In the authentication step 715 the username is received (e.g. by user input) as well as a hash string 718 representative of the user's passcode in the user profile 728 which is stored. If a person wishes to gain access to some functionality of a device by demonstrating themselves to be the authorised user, then the user can enter a passcode comprising the position and force data as discussed above, and this is provided to a profile match step 726. The user's stored profile is also accessible in the profile match step 726 from the profile database 728 which is received as stored user credentials from the user profile. If, in matching step 726, the user's entered details match those stored for the user, then authentication is successful in step 732, and for example additional functionality can be unlocked or enabled. If, in matching step 726, the user's entered details do not match those stored for the user, then authentication has failed in step 730 and the user does not gain access to the additional functionality. In some examples the device which the user is attempting to gain access to may be further locked down and require additional special unlocking by a user to be able to access the device again.

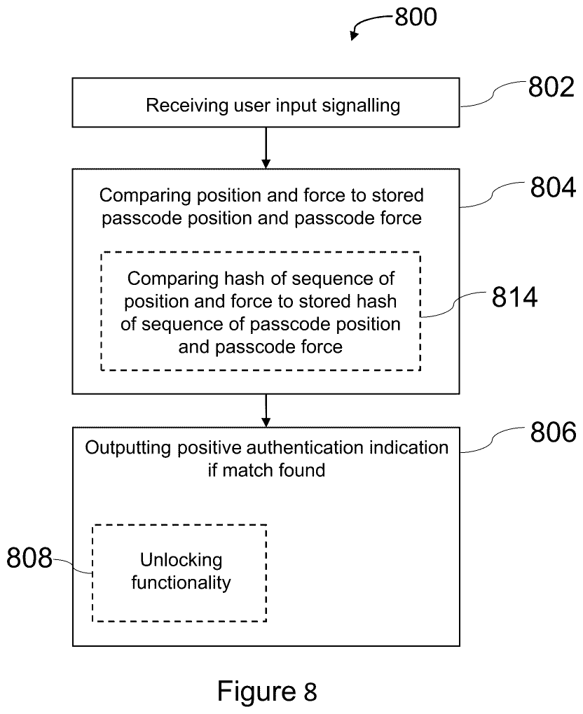

FIG. 8 illustrates an example method of user authentication 800, the method comprising: receiving signalling indicative of one or more user inputs in a sequence provided to a sensing surface of a force sensor 802, each of the user inputs of the sequence having an associated position and an associated force; comparing the associated position and the associated force of each of the user inputs in the sequence with a passcode position and a passcode force of a passcode sequence 804, the passcode sequence stored in a memory accessible by the apparatus; and outputting a positive authentication indication in response to the associated position and the associated force of each of the user inputs in the sequence matching the corresponding passcode position and the passcode force of the passcode sequence 806. Comparing the associated position and the associated force of each of the user inputs in the sequence with a passcode position and a passcode force of a passcode sequence 804 may comprise comparing a hash of the associated position and the associated force of each of the user inputs in the sequence with a hash of a passcode position and a passcode force of a passcode sequence 814.

Outputting the positive authentication indication in response to the associated position and the associated force of each of the user inputs in the sequence matching the corresponding passcode position and the passcode force of the passcode sequence may comprise unlocking functionality of a device 808 associated with the stored passcode.

The method 800 may be performed by computer program code which, when executed on a processor, is configured to perform the method. The computer program code may be stored on a non-transitory computer readable medium.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

It will be appreciated that various changes and modifications can be made to the present invention without departing from the scope of the present application.

1. An apparatus for user authentication, the apparatus configured to:
receive signalling indicative of one or more user inputs in a sequence provided to a sensing surface of a force sensor, each of the user inputs of the sequence having an associated position and an associated force;
compare the associated position and the associated force of each of the user inputs in the sequence with a passcode position and a passcode force of a passcode sequence, the passcode sequence stored in a memory accessible by the apparatus; and
output an positive authentication indication in response to the associated position and the associated force of each of the user inputs in the sequence matching the corresponding passcode position and the passcode force of the passcode sequence.

2. The apparatus of claim 1, wherein each of the associated positions corresponds to respective keys of a keyboard, the respective key having an associated key value and configured to apply force to the force sensor at the corresponding associated positions, and wherein the passcode position of a passcode sequence corresponds to an associated passcode key value.

3. The apparatus of claim 1, wherein the apparatus is further configured to output a negative authentication indication in response to determining that the associated position and the associated force of each of the user inputs in the sequence do not match the corresponding passcode position and the passcode force of the passcode sequence.

4. The apparatus of claim 1, wherein the passcode position and the passcode force of the passcode sequence are combined and hashed to obtain a hashed passcode sequence, and the apparatus is configured to:
hash the associated position and the associated force of each of the user inputs in the sequence to obtain a hashed sequence using the same hashing method as that used to hash the passcode position and the passcode force of the passcode sequence to obtain the hashed passcode sequence;
compare the hashed sequence with the hashed passcode sequence; and
output the positive authentication indication in response to the hashed sequence matching the hashed passcode sequence.

5. The apparatus of claim 4, wherein the associated position and the associated force of each of the user inputs in the sequence are hashed together to provide a single hashed sequence.

6. The apparatus of claim 1, wherein the associated force falls within an associated force range of a plurality of predetermined force ranges, and wherein each of the one or more passcode forces is associated with a corresponding predetermined force range of the plurality of predetermined force ranges; and the apparatus is configured to:
compare the associated force to the plurality of predetermined force ranges;
determine an associated force range of the plurality of predetermined force ranges into which the associated force falls;
compare the associated force range of each of the user inputs in the sequence with the passcode force range of the passcode sequence, the passcode force range being one of the plurality of predetermined force ranges; and
output an positive authentication indication in response to the associated position and the associated force range of each of the user inputs in the sequence matching the corresponding passcode position and a corresponding passcode force range of the passcode sequence.

7. The apparatus of claim 6, wherein the plurality of predetermined force ranges have respective upper and lower force bounds, the respective upper and lower force bounds determined according to a sample of user inputs provided to the sensing surface of the force sensor.

8. The apparatus of claim 1, wherein the apparatus is configured to:
process the received signalling indicative of one or more user inputs in a sequence having an associated position and an associated force using an trained AI model to determine the associated force.

9. The apparatus of claim 1, where the positive authentication indication comprises one or more of:
a visual indicator output to alert a user of the apparatus that the sequence matches the passcode sequence;
an audio indicator output to alert a user of the apparatus that the sequence matches the passcode sequence;
a haptic indicator output to alert a user of the apparatus that the sequence matches the passcode sequence; and
unlocking functionality of a device associated with the passcode sequence.

10. The apparatus of claim 1, further configured to, in response to receiving each of the user inputs having an associated position and an associated force, output a force input indicator indicative of a magnitude of the force applied.

11. A system comprising:
the apparatus of claim 1; and
a force sensor configured to detect the position and the force of a user input provided to a sensing surface of the force sensor, and transmit the signalling indicative of one or more user inputs in a sequence provided to the sensing surface of the force sensor to the apparatus.

12. The system of claim 11, comprising at least one control module connected to the force sensor, the control module configured to convert an analogue force signal received from the force sensor in response to a force applied to the force sensor, to a digital force signal representative of the force applied to the force sensor.

13. The system of claim 11, comprising a plurality of keys forming a keyboard, wherein each key of the plurality of keys is configured to, when a force is applied to that key, apply a corresponding force to the force sensor at a position corresponding to that key.

14. The system of claim 11, comprising a display surface configured to display a virtual keyboard comprising a plurality of virtual keys, wherein each virtual key of the plurality of virtual keys is configured to, when a force is applied to that virtual key, apply a corresponding force to the force sensor at a position corresponding to that virtual key.

15. The system of claim 12, wherein the system forms a keyboard device.

16. A method for user authentication, the method comprising:
receiving signalling indicative of one or more user inputs in a sequence provided to a sensing surface of a force sensor, each of the user inputs of the sequence having an associated position and an associated force;
comparing the associated position and the associated force of each of the user inputs in the sequence with a passcode position and a passcode force of a passcode sequence, the passcode sequence stored in a memory; and
outputting a positive authentication indication in response to the associated position and the associated force of each of the user inputs in the sequence matching the corresponding passcode position and the passcode force of the passcode sequence.

17. The method for user authentication of claim 16, wherein outputting the positive authentication indication in response to the associated position and the associated force of each of the user inputs in the sequence matching the corresponding passcode position and the passcode force of the passcode sequence comprises unlocking functionality of a device associated with the stored passcode sequence.

18. Computer program code which, when executed on a processor, is configured to perform the method of claim 16.
